(19) United States
(12) Patent Application Publication
(10) Pub. No.: US 2011/0235513 A1
(43) Pub. Date: Sep. 29, 2011

(54) PACKET SCHEDULING IN A WIRELESS LOCAL AREA NETWORK

(75) Inventor: Ahmed Ali, Ontario (CA)

(73) Assignee: INTERDIGITAL TECHNOLOGY CORPORATION, Wilmington, DE (US)

(21) Appl. No.: 13/111,651

(22) Filed: May 19, 2011

Related U.S. Application Data
(63) Continuation of application No. 10/991,266, filed on Nov. 17, 2004.
(60) Provisional application No. 60/535,016, filed on Jan. 8, 2004.

(51) Int. Cl. H04L 12/26

(52) U.S. Cl. 370/232

(57) ABSTRACT

A method is described including deriving, by a wireless device, a first value for each of a plurality of queues. The first value is derived from a second value and a delay between scheduling transmissions for that data queue. The second value is associated with a data rate, and each of the plurality of data queues is associated with a priority. Data is selected by the wireless device from at least one of the priority queues for transmission based on the derived first value. Also described is a wireless device with a plurality of data cues and circuitry configured for each of the plurality of cues to derive the first value and to select data from at least one of the priority queues for transmission based on the derived first value.

### CROSS REFERENCE TO RELATED APPLICATION

This application is a continuation of U.S. patent application Ser. No. 10/991,266, filed Nov. 17, 2004, which claims the benefit of U.S. Provisional Application No. 60/535,016, filed Jan. 8, 2004, which are incorporated by reference as if fully set forth herein.

### FIELD OF INVENTION

The present invention generally relates to wireless communication systems, and in particular, to scheduling packets of traffic flows in wireless local area networks (WLANs).

### BACKGROUND

In an 802.11e-based environment, the enhanced distributed coordination function (EDCA) classifies traffic flows into access categories (ACs) reflecting the priority of the application carried by each traffic flow. Different arbitration interframe space (AIFS), minimum contention window (CWmin), and maximum contention window (CWmax) parameters are allocated per traffic flow according to its AC. The AIFS is the period of time that a station (STA) waits after receiving an acknowledgement from an access point (AP) that a previously transmitted packet was received. A higher priority AC has a shorter AIFS than a lower priority AC, such that higher priority traffic has a shorter wait time before accessing the channel. The CWmin and CWmax values define the lower and upper bounds for a contention window, which is used during a back-off procedure. The EDCA helps to ensure that higher priority traffic flows have a greater chance of gaining access to the channel through favorable settings of AIFS, CWmin, and CWmax.

The 802.11e standard specifies the contention and back-off mechanism amongst the various ACs. However, scheduling at the AP among different traffic flows (belonging to different STAs) within the same AC is not specified by the standard, and is left to the AP implementation.

### SUMMARY

A method is described including deriving, by a wireless device, a first value for each of a plurality of queues. The first value is derived from a second value and a delay between scheduling transmissions for that data queue. The second value is associated with a data rate, and each of the plurality of data queues is associated with a priority. Data is selected by the wireless device from at least one of the priority queues for transmission based on the derived first value. Also described is a wireless device with a plurality of data cues and circuitry configured for each of the plurality of cues to derive the first value and to select data from at least one of the priority queues for transmission based on the derived first value.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flowchart showing a method for scheduling packets in accordance with the present invention;

FIG. 2 is a diagram showing EDCA functionality with a QoS-based contention resolution function operating on multiple traffic flows;

FIG. 3 is a flowchart of the contention resolution function operating within the same AC; and

FIG. 4 is a diagram of the contention resolution function shown in FIG. 3.

### DETAILED DESCRIPTION OF THE PREFERRED EMBODIMENTS

The present invention implements a quality of service (QoS)-based internal contention resolution function at the AP. The QoS-based function operates per AC to resolve contention among the multiple traffic flow queues within the same AC.

The contention resolution function is triggered whenever there are packets in two or more traffic flow queues at the same AC, and both queues are attempting to access the channel at the frame transmission time. The output of the contention resolution function is the internal contention priority for each AC, which is the priority used to access the channel.

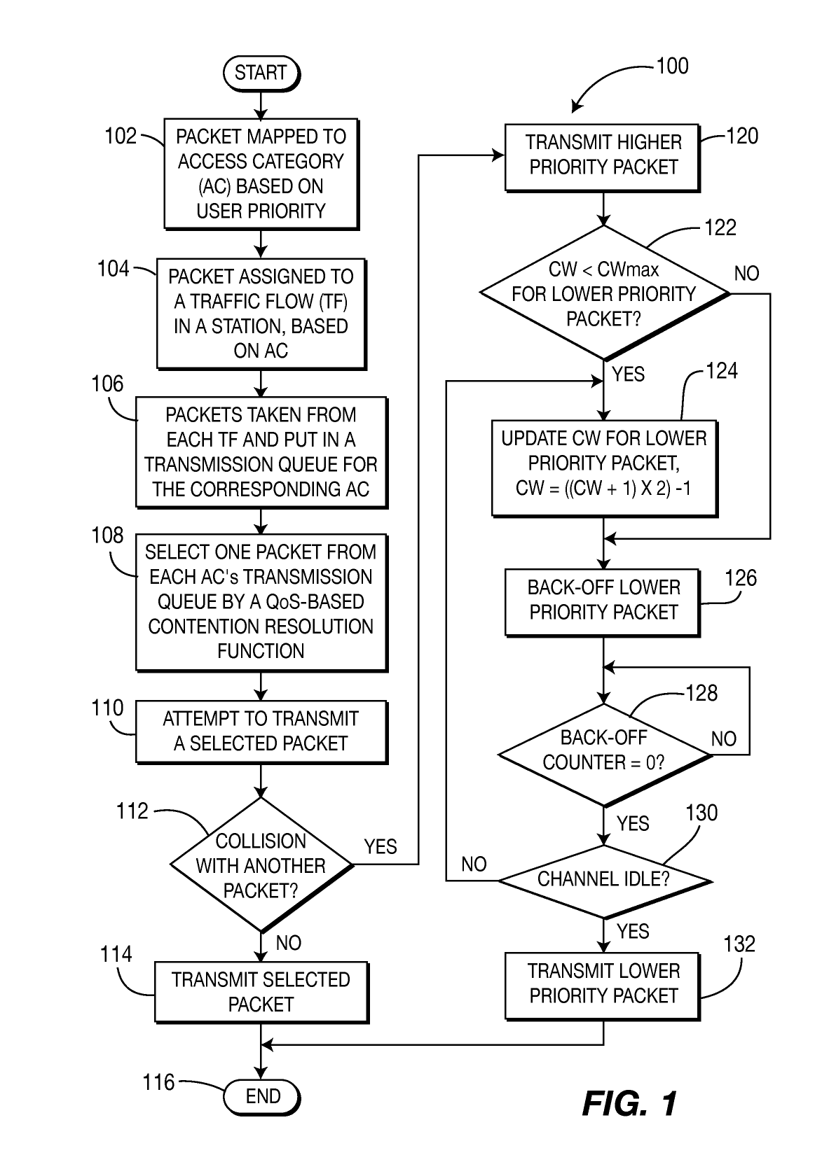

The operation of the delay-based QoS function 100 is shown in FIG. 1 and is described within the context of EDCA operation. The EDCA function supports four ACs. Eight different user priorities (UPs) are mapped into these four ACs as shown in Table 1.

TABLE 1
User Priority to Access Category mapping

| | User | | | | |
|---|---|---|---|---|---|
| | priority | | | | |
| | (UP - | | | | |
| | Same as | | | | |
| | 802.1D | | Access | | |
| | User | 802.1D | Category | Designation | Typical |
| Priority | Priority) | Designation | (AC) | (Informative) | Designation |
| Lowest | 1 | BK | AC_BK | Background | AC_1 |
| | 2 | — | AC_BK | Background | AC_1 |
| | 0 | BE | AC_BE | Best Effort | AC_2 |
| | 3 | EE | AC_VI | Video | AC_3 |
| | 4 | CL | AC_VI | Video | AC_3 |
| | 5 | VI | AC_VI | Video | AC_3 |
| | 6 | VO | AC_VO | Voice | AC_4 |
| Highest | 7 | NC | AC_VO | Voice | AC_4 |

A packet to be transmitted by a STA is mapped into an AC, based on its UP (step 102). The mapping function ensures that the UPs are mapped into the respective ACs, and that packets from the different traffic flows are directed to their respective queues in their AC.

In the 802.11e standard, a STA can have one or more traffic flows and the traffic flows could be scattered across the ACs or be grouped into the same AC, depending on the applications being run from that STA and the number of simultaneous sessions of the same application. For implementation purposes, each STA is restricted to having a maximum of four traffic flows, and each traffic flow supports a different application. It is noted that a STA can have more than four traffic flows and can support simultaneous sessions of the same application; the present invention would still operate in the same manner in such circumstances.

Therefore, an AC can support up to a maximum of N traffic flows, where N is the number of STAs in the system. An AC can have no traffic flows if none of the STAs are running an application that belongs to that AC.

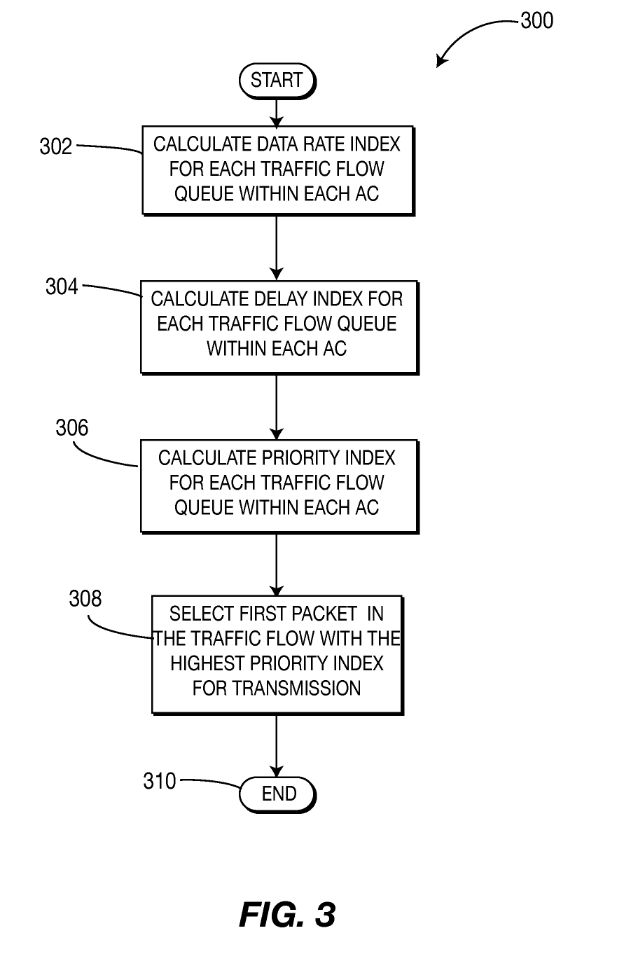

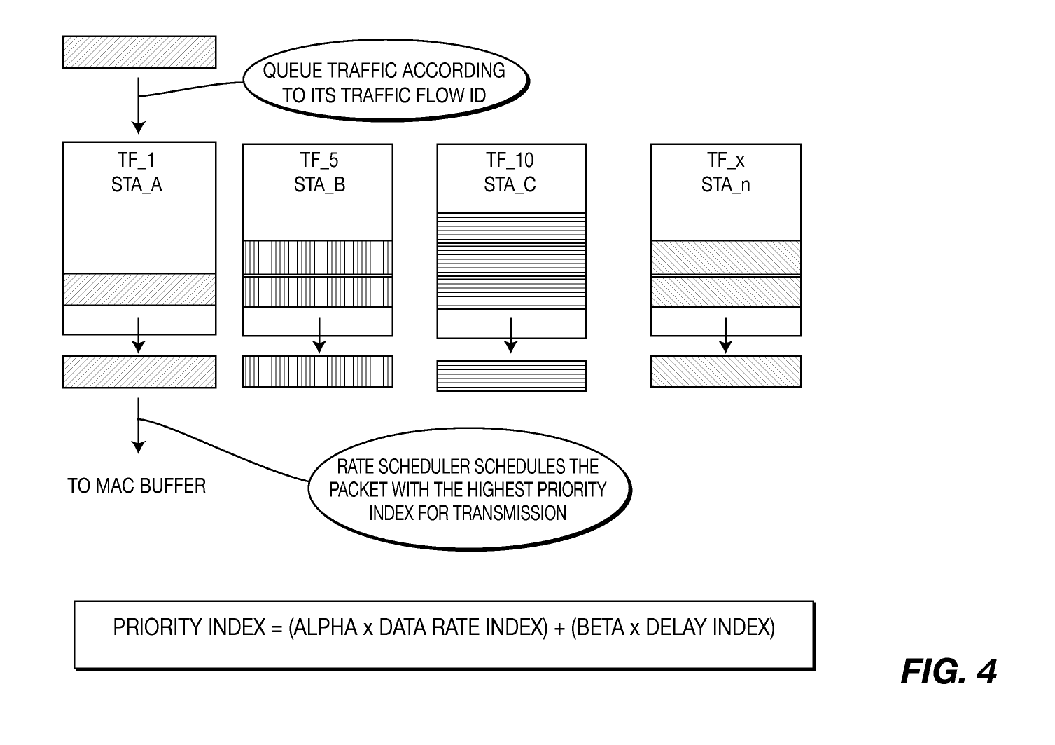

A packet is assigned to a traffic flow in a STA based on its AC (step 104). Packets from each traffic flow are placed into a transmission queue for the corresponding AC (step 106). One packet from the transmission queue from each AC is selected by the QoS-based contention resolution function, based on the AC's transmission rate and delay requirements (step 108; this function is described in greater detail in connection with FIGS. 3 and 4). An attempt is made to transmit a selected packet (step 110), and a determination is made whether there would be a transmission collision with another packet (step 112). If there would not be a collision, then the selected packet is transmitted (step 114) and the function terminates (step 116).

If there would be a collision with another packet (step 112), then the higher priority packet is transmitted (step 120). The contention window value (CW) for the lower priority packet is compared with the CWmax value for the AC associated with that packet (step 122). If the CW value is less than CWmax, then the CW value is updated as shown in Equation 1 (step 124).

CW=((CW+1)×2)−1 Equation (1)

After the CW value is updated or if CW is already at CWmax (step 122), then the lower priority packet enters a back-off mode for a time period equal to CW (step 126) and a countdown timer is started. Once the countdown timer reaches zero (step 128), then a determination is made whether the channel is idle by carrier sense multiple access with collision avoidance (CSMA/CA) sensing (step 130). If the channel is not idle, then the function returns to step 124 to reset the CW value and restart the countdown timer. If the channel is idle, then the lower priority packet is transmitted (step 132) and the function terminates (step 116).

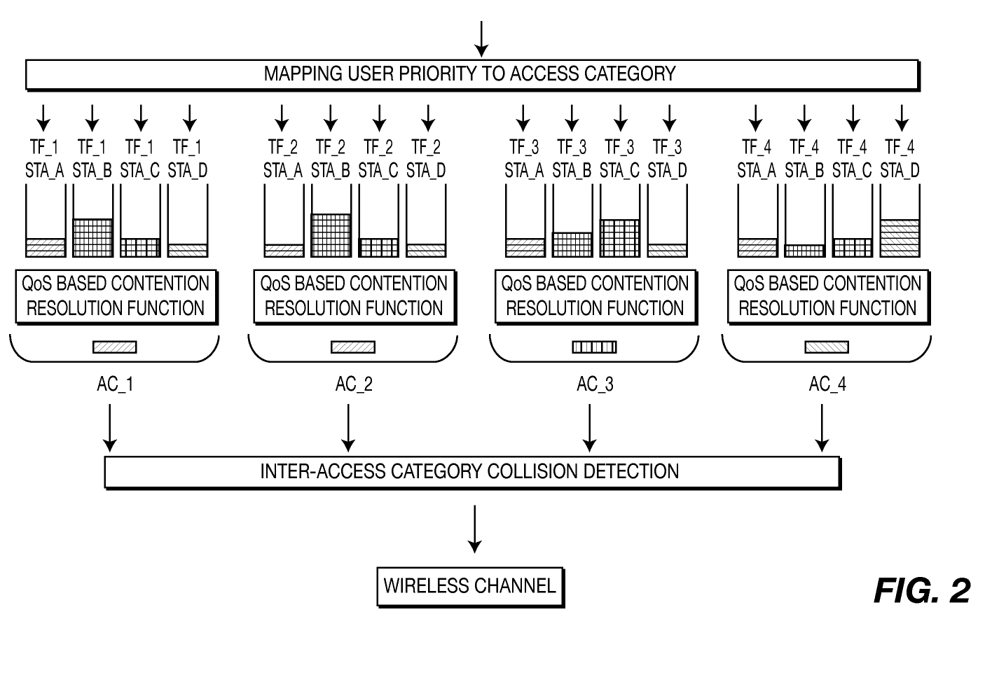

The function 100 will now be described in connection with FIG. 2, which shows an example of an EDCA implementation model having four STAs, each running four different applications mapped on different ACs, creating one traffic flow of each STA in each AC. A packet is assigned to a traffic flow in a STA, based on its AC, for example, a second traffic flow (TF_2) from station B (STA_B) is in AC_2. Packets from each traffic flow are inserted into a separate transmission queue, and the QoS-based contention resolution function nominates one packet from each AC to be transmitted.

Once a packet is chosen from an AC, for example AC_2, and it is ready for transmission (i.e., it is not in back-off mode and it is sensing that the channel is idle), then it will attempt transmission on the channel. If there is another packet ready for transmission from another AC, for example AC_4, this causes an internal collision among ACs. In this case, the packet from AC_2 (lower priority) will allow the AC with the higher priority (AC_4) the right to access the channel and transmit. AC_2 updates its CW[AC_2] to the value ((CW[AC_2]+1)×2)−1 or leaves the CW value unchanged if CW[AC_2] has already reached CWmax[AC_2].

The packet from AC_2 then begins a back-off procedure, and decrements its back-off counter until it reaches zero. If the channel is then idle, the packet attempts transmission. Until the packet from AC_2 gets transmitted, the QoS-based contention resolution function will not be triggered for AC_2, and no other packets will be nominated for transmission for AC_2 category.

If the back-off timer has reached zero for the waiting packet in AC_2, and there are no packets from other categories that the AC_2 packet could collide with, then AC_2 will transmit that packet. If a collision occurred, it would have to initiate a new back-off procedure and update its CW[AC_2] according to the value ((CW[AC_2]+1)×2)−1.

Following a successful transmission, an AC that has just sent the final transmission within its allowed transmission opportunity (TXOP) will update its CW[AC] value and will initiate a back-off procedure to the next nominated packet regardless of the occurrence of a collision with a higher priority AC. A TXOP is a point in time when a STA can begin transmitting frames for a given duration. During a TXOP, a STA can transmit as many frames as possible in the TXOP, the length of which is set according to the traffic class (TC) associated with the data. EDCA TXOP should not exceed the TXOP limit advertised by the AP. This is necessary to ensure that higher priority ACs will not continuously starve the lower priority ACs within the AP whenever they have something to transmit, and that the prioritization is done through the favorable setup values of CWmin[AC], CWmax [AC] and AIFS [AC].

In EDCA, a traffic flow will initiate a back-off procedure in the following three cases:

1. Due to an internal collision with higher ACs.

2. Due to an external collision with another STA sharing the wireless channel.

3. After the final transmission within the allocated TXOP after nominating another packet for transmission.

If there is only one traffic flow queue in a certain AC, then the QoS-based contention resolution function will not be effective, as there are no other queues to contend with.

Contention Resolution Function

Within each queue, a Priority Index is calculated based on Delay and Data Rate criteria. The Data Rate Index calculation takes into consideration the instantaneous data rate used to transmit the packet. A higher data rate requires less medium time and is thus given a higher priority. This improves the overall throughput of the system, but may increase the delay for users with low instantaneous data rates. The Delay Index calculation takes into consideration the delay of the first packet in every queue (i.e., the time that the packet has spent in the queue) and the size of the queue, to reflect QoS requirements per traffic flow. The packet with the highest Priority Index (a combination of the Data Rate and Delay) within the same AC is then scheduled to compete for transmission with the other ACs.

FIG. 3 shows a flowchart of the contention resolution function 300, which determines the next packet to schedule based on the estimated data rate and the current delays incurred by the packet. The contention resolution function 300 is also shown diagrammatically in FIG. 4.

One queue exists for each AC and is indexed with “n”. Within each queue, a Priority Index is calculated for each packet based on Delay and Data Rate criteria. The Delay Index includes AC-dependent parameters.

The Data Rate Index of each queue within AC, is calculated according to Equation 2 (step 302):

$$Data Rate Index = \frac{transmission data rate}{maximum data rate} \qquad Equation ( 2 )$$

where the maximum data rate is the maximum data rate allowed in the applicable standard. For example, in 802.11b the maximum data rate is 11 Mbps and in 802.11g the maximum data rate is 54 Mbps.

The Delay Index of each queue within ACₙ is described in Equation 3 (step 304):

Delay Indexₙ=(A[ACₙ]×First_Pkt_Delayₙ(normalized))+(B[ACₙ]×Queue_Sizeₙ)+(C[ACₙ]×Avg_Pkt_Delayₙ(normalized)) Equation (3)

where First_Pkt_Delay, is the delay experienced by the first packet in ACE, Queue_Sizeₙ is the size of ACₙ, and Avg_Pkt_Delayₙ is a moving average of the packet delay of ACₙ over M packets. A, B, and C are weighting factors per AC for the packet delay, the queue size, and the average packet delay, respectively. Initial values for the weighting factors that can be applied to all ACs as a starting point are: A=0.4, B=0.3, and C=0.3. The values of A, B, and C can be adjusted during operation by monitoring the average queue size. If the queue size grows too large, the value of C can be increased while decreasing the value of A or B. Alternately, depending on the AC, different settings may be used for the three weighting factors, which emphasizes the different QoS aspects of the traffic carried by each AC and which more effectively determines the priority in accessing the channel.

The first and third terms of the Delay Index equation are normalized to an integer value so as not to be overshadowed by the second term, which is the size of the queue. The queue with the highest Delay Index calculation will have a higher probability of gaining the right to access the channel, as per the Priority Index calculation (step 306):

Priority Index=(Alpha×Data Rate Index)+(Beta×Delay Index) Equation (4)

where Alpha is a weighting factor to dampen the impact of the transmission data rate and Beta is a weighting factor to dampen the impact of the delay. In one embodiment of the present invention, Alpha=0.5 and Beta=0.5. These values can be adjusted over time by monitoring the number of packets that experience a delay of X seconds. If the number of packets exceeds 10% (this value can be configured), then adjustments could be made to the weights of Alpha and Beta; e.g., decrease Alpha and increase Beta.

The first packet in the traffic flow with the highest Priority Index value is selected for transmission (step 308) and the function terminates (step 310).

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A wireless device comprising:
a plurality of data queues; wherein each of the plurality of data queues is associated with a priority; and
circuitry configured for each of the plurality of queues to derive a first value; wherein the first value is derived from a second value and a delay between scheduling transmissions for that data queue; wherein the second value is associated with a data rate; wherein the circuitry is further configured to select data from at least one of the priority queues for transmission based on the derived first value.

2. The wireless device of claim 1 wherein the selection of data prevents starvation of transmission resources of lower priority data.

3. A method comprising:
deriving, by a wireless device, a first value for each of a plurality of queues; wherein the first value is derived from a second value and a delay between scheduling transmissions for that data queue; wherein the second value is associated with a data rate; wherein each of the plurality of data queues is associated with a priority;
selecting, by the wireless device, data from at least one of the priority queues for transmission based on the derived first value.

4. The method of claim 3 wherein the selection of data prevents starvation of transmission resources of lower priority data.
